(19) United States
(12) Patent Application Publication
(10) Pub. No.: US 2026/0064500 A1
(43) Pub. Date: Mar. 5, 2026

(54) TIME DIVISION MULTIPLEXING SHARED MEMORY

(71) Applicant: Tenstorrent USA, Inc., Austin, TX (US)

(72) Inventors: Thomas L. Drabenstott, Cary, NC (US); Syed Gilani, Markham (CA); Rakesh Shaji Lal, Hamilton (CA); Shaun Wandler, Austin, TX (US)

(21) Appl. No.: 19/314,526

(22) Filed: Aug. 29, 2025

Related U.S. Application Data
(60) Provisional application No. 63/689,281, filed on Aug. 30, 2024.

(51) Int. Cl. G06F 9/54

(52) U.S. Cl. CPC G06F 9/544

(57) ABSTRACT

Systems and methods related to time division multiplexing shared memories are disclosed herein. A shared memory system may use time division access techniques, lane access techniques, or both to reduce the complexity of cross bar circuits while maintaining high throughput. The memory system may comprise a set of port groups, a set of selection circuits coupled to the set of port groups in a one-to-one correspondence, a set of memory banks, and a time division multiplexing control system. The time division multiplexing control system may be coupled to a set of control inputs of the set of selection circuits, and may be configured to couple, in a cycle of one-to-one correspondences, the set of port groups to the set of memory banks. The memory system may divide memory banks and client ports into separate lanes based on address bits, where each lane operates independently with dedicated routing circuits.

### CROSS REFERENCE TO RELATED APPLICATIONS

This application claims the benefit of U.S. Provisional Patent Application No. 63/689,281, filed Aug. 30, 2025, which is incorporated by reference herein in its entirety for all purposes.

### BACKGROUND

Multiported memories are critical components in multicore processor environments, where multiple cores need simultaneous access to shared data. These memory architectures feature multiple read and write ports, enabling several processors to access the memory concurrently without creating bottlenecks or contention. This parallel access capability significantly enhances performance by reducing latency and improving throughput, which is essential in high-performance computing, real-time processing, and other demanding applications. In multicore systems, multiported memories are often used in cache hierarchies, register files, and shared memory modules, where they provide the required bandwidth and low-latency access paths. By allowing multiple cores to efficiently communicate and share data, multiported memories contribute to maximizing the overall computational efficiency and scalability of multicore processors.

Despite their performance advantages, multiported memories come with significant drawbacks, primarily related to complexity and cost. As the number of ports and memory addresses increases, the routing and control logic required to manage simultaneous access grows exponentially more complex. For example, in a banked memory system, the cross bar (which connects ports to banks) can become very large and complex. For example, a system with 256 ports and 256 banks, each with a 128-bit data width, has a cross bar complexity that grows with the square of the number of ports and banks (approximately N×(M-1) where N=M=256 (approximately N×(M-1) where N=M=256).

This complexity necessitates additional hardware resources, which can lead to increased power consumption and a larger silicon footprint. The intricate interconnections and multiplexing circuitry required for efficient multiport operation can make the design and fabrication of these memories challenging and expensive. Moreover, ensuring data consistency and avoiding conflicts in multiported memory systems often requires sophisticated arbitration mechanisms, which can further complicate the design. As a result, while multiported memories offer substantial benefits in terms of performance and scalability, their implementation must be carefully balanced against these challenges to optimize cost, power efficiency, and overall system reliability.

### SUMMARY

This disclosure relates to shared memory systems in computing architectures where the shared memory system is shared by multiple clients. The shared memory systems can be multiported memories where the multiple ports are coupled to multiple clients of the subsystem. Specific embodiments disclosed herein alleviate the increase in complexity of the routing circuitry required for a multiported memory as the number of ports and the number of memory addresses in the multiported memory increase. Given that multiported memories offer significant advantages when used in systems with a large number of clients, alleviating the pressure placed on multiported memories, as the number of ports increases, can present significant benefits. In specific embodiments of the inventions disclosed herein, multiported memories with 256 or more ports and 256 or more banks are possible without undue complexity or increased cost incurred by the design. Given that the complexity and size of multiported memories increases by, at a minimum, a multiplicative relationship with both numbers, the disclosed systems can present significant benefits.

In specific embodiments of the inventions disclosed herein, a time division multiplexing shared memory is disclosed. The shared memory can be a multiported memory in which sets of ports are given time division access to memory banks in a set of memory banks of the multiported memory. As used herein, the term memory bank refers to one or more addressable storage locations in a memory. The shared memory can be designed so that sets of ports cycle through a cycle of one-to-one correspondences with the set of memory banks such that each set of ports has temporary access to one subset of the set of memory banks in each portion of the cycle and has access to the entire set of memory banks through the course of an entire cycle. Using this approach, the routing and arbitration complexity for the multiported memory can be significantly reduced. Furthermore, specific embodiments of the invention disclosed herein, such as those using data swizzling, alleviate the problems associated with sets of ports having their access to memory banks limited for some of the portions of the cycle.

In specific embodiments of the inventions disclosed herein, a lane access shared memory is disclosed. The lane access shared memory may reduce routing circuit complexity by dividing both the memory banks and client ports into separate, independent lanes based on specific address bits of memory access requests. In this approach, access requests are sorted into different lanes using the least significant bits (LSBs) of their memory addresses, with each lane containing a subset of the total memory banks and being served by dedicated routing circuits such as cross bars. For example, in a system with four lanes, the two LSBs of each access request's address may determine which lane processes that request, with each lane handling one-fourth of the total memory banks through smaller, less complex routing circuits. Each lane may include dedicated buffers to manage request timing and flow control, allowing the system to handle varying request rates across different lanes. This lane-based architecture enables the memory system to achieve high throughput through parallel processing while significantly reducing the complexity of individual routing circuits, as each cross bar only needs to route between a smaller number of inputs and outputs compared to a monolithic routing system. The technique may be particularly effective when combined with data swizzling schemes that distribute contiguously addressed data across different lanes, ensuring that sequential memory accesses can utilize multiple lanes simultaneously and maintain optimal bandwidth utilization. In specific embodiments of the inventions disclosed herein, the shared memory may use time division multiplexing, lane access, or both.

In specific embodiments of the invention, a shared memory system is provided. The system comprises: a set of port groups; a set of selection circuits coupled to the set of port groups in a one-to-one correspondence; a set of memory banks; and a time division multiplexing control system, coupled to a set of control inputs of the set of selection circuits, to couple, in a cycle of one-to-one correspondences, the set of port groups through the set of selection circuits to the set of memory banks.

In specific embodiments of the invention, a shared memory system is provided. The system comprises a set of memory banks and a set of cross bar circuits. Each cross bar circuit of the set of cross bar circuits is uniquely coupled with a memory bank of the set of memory banks. The system also comprises a selection circuit selectively coupled to each cross bar circuit of the set of cross bar circuits. The selection circuit routes an access request to a cross bar circuit of the set of cross bar circuits based on one or more least significant bits of a memory address of the access request.

In specific embodiments of the invention, a method for operating a shared memory system is provided. The method comprises coupling a set of port groups through a set of selection circuits to a set of memory banks in a cycle of one-to-one correspondences based on a time division multiplexing control system coupled to a set of control inputs of the set of selection circuits. The set of selection circuits are coupled to the set of port groups in a one-to-one correspondence.

In specific embodiments of the invention, a method for operating a shared memory system is provided. The method comprises routing, via a selection circuit, an access request to a cross bar circuit of a set of cross bar circuits based on one or more least significant bits of a memory address of the access request. The selection circuit is selectively coupled to each cross bar circuit of the set of cross bar circuits and each cross bar circuit is uniquely coupled with a memory bank of a set of memory banks.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 presents a multiported memory with 256 addressable memory addresses and 256 clients to illustrate some of the concepts used to describe multiported memories used herein.

FIG. 2 provides an example of a shared memory system using time division multiplexing in accordance with specific embodiments of the inventions disclosed herein.

FIG. 3 provides an example of a cycle of one-to-one correspondences where selection circuits are coupled to routing circuits in different one-to-one correspondences throughout the cycle based on control outputs from a time division multiplexing (TDM) control system in accordance with specific embodiments of the inventions disclosed herein.

FIG. 4 provides an example of a set of arbitrators that each uniquely receive a series of memory access requests in accordance with specific embodiments of the inventions disclosed herein.

FIG. 5 provides an example of an addressing scheme and data swizzling in a shared memory that is in accordance with specific embodiments of the inventions disclosed herein.

FIG. 6 provides an example of lane access to the different banks in a shared memory system in accordance with specific embodiments of the inventions disclosed herein.

FIG. 7 provides an example of an addressing scheme and data swizzling in a shared memory using lane access in accordance with specific embodiments of the inventions disclosed herein.

FIG. 8 provides an example of a shared memory system that uses lane access division inside time division in accordance with specific embodiments of the inventions disclosed herein.

FIG. 9 provides an example of a shared memory system that uses time division inside lane access division in accordance with specific embodiments of the inventions disclosed herein.

FIG. 10 provides an example of multiplexers of a shared memory system dividing access requests using both lane division and time division in accordance with specific embodiments of the inventions disclosed herein.

FIG. 11 provides an example of a response buffer system in accordance with specific embodiments of the inventions disclosed herein.

FIG. 12 provides an example of a method for operating a shared memory system using time division multiplexing in accordance with specific embodiments of the inventions disclosed herein.

FIG. 13 provides an example of a method for operating a shared memory system using lane access in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for time division multiplexing shared memories in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Systems and methods related to shared memory systems in computing architectures in accordance with the summary above are disclosed herein. The shared memory systems can be multiported memories coupled to multiple clients of the memory subsystem. The clients can be computational cores, shader cores, network ports or channels, buffers, DSP cores or filters, specialized hardware accelerators, cache controllers, I/O devices, hardware threads, memory management units (MMUs), random access memory controllers, network on chip interfaces, or any other form of computational unit or network port that can benefit from low latency access to a shared memory. The clients can also be components of the elements mentioned above. For example, the clients could be specialized packer blocks or unpacker blocks designed to obtain or store computation data in memory in a different format from the format in which it is manipulated in a computational pipeline. The shared memory systems can provide numerous clients with access to all the addresses in the shared memory each clock cycle, so long as an arbitrator determines that multiple clients are not trying to access the same address, without the associated complexity and cost of prior art multiported memories.

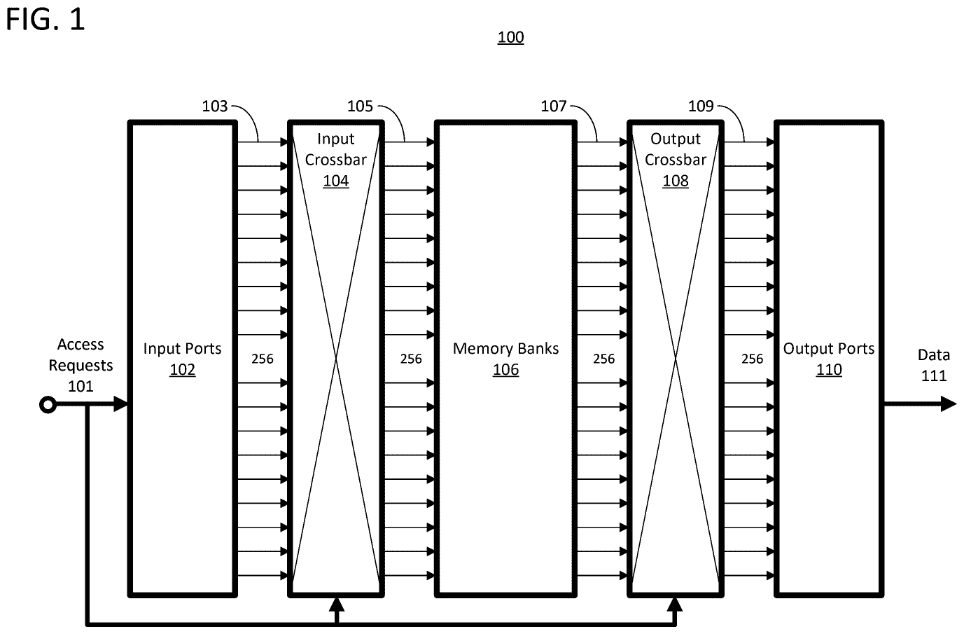

FIG. 1 presents multiported memory 100 with 256 addressable memory addresses and 256 clients to illustrate some of the concepts used to describe multiported memories used herein. To simplify the diagram, only eighteen connections are shown for each of connections 103, 105, 107, and 109; however, there may be 256 of each of these connections to accommodate the 256 addressable memory addresses and 256 clients. Access requests 101 for multiported memory 100 are received on the left side of the diagram. Access requests 101 include address information which may configure the state of input cross bar 104 and output cross bar 108 to link specific ports with specific memory banks 106. This includes both input ports 102 and output ports 110 of the shared memory. Access requests 101 may include an identity of the type of access required by the access request (e.g., a read or write request), and an address in memory banks 106 that is the subject of the request. Write requests can additionally include the write data that is to be written at the address. Read requests can have null data in the portion of the request that is otherwise used for the write data, or the read requests can be smaller data structures.

In the illustrated case in FIG. 1, the memory subsystem can receive a total of 256 access requests on its 256 ports in a given clock cycle. In specific embodiments, the memory subsystem can service those 256 requests in a subsequent clock cycle. The subsystem can service the requests by configuring the cross bar and then either reading the data from the memory banks 106 and providing it to the selected output port 110 or writing the data from the access request on an input port 102 to the selected address. Output ports 110 may output data 111. An arbitration circuit, not shown, can be used to assure that all the 256 access requests in a given cycle will not conflict (e.g., none of the requests in a given clock cycle refer to the same address in the memory banks). Additional software or higher-level hardware can assure that the use of the memory banks as a whole by one client does not create a conflict with any other client. This can be achieved by reserving written data for specific clients or preventing any given client or port from writing data to certain addresses in the memory banks. Specific embodiments of the inventions disclosed herein use techniques that maintain performant high throughput by supporting out-of-order issue and completion of access requests. This can be conducted by the software or higher-level hardware mentioned above and allows access requests to proceed to issue while one or more other requests wait for their chance to access a particular memory bank. This can be conducted by first in first out (FIFO) circuits that gather out-of-phase requests across multiple ports, merge them for issue, and then redirect the responses upon return.

The complexity of the memory system in FIG. 1 is relatively high because two complex cross bars are required. Each cross bar is configured to route any of 256 inputs to any of 256 outputs. The required number of states for each of the two cross bars is therefore 65,536, which is a large number of states for a working memory to need to adopt. The complexity of the cross bar increases exponentially with the increase in the number of states. Furthermore, the number of ports and clients is likely to increase as the number of computational units that need to share a low latency memory in high performance computing applications continues to increase.

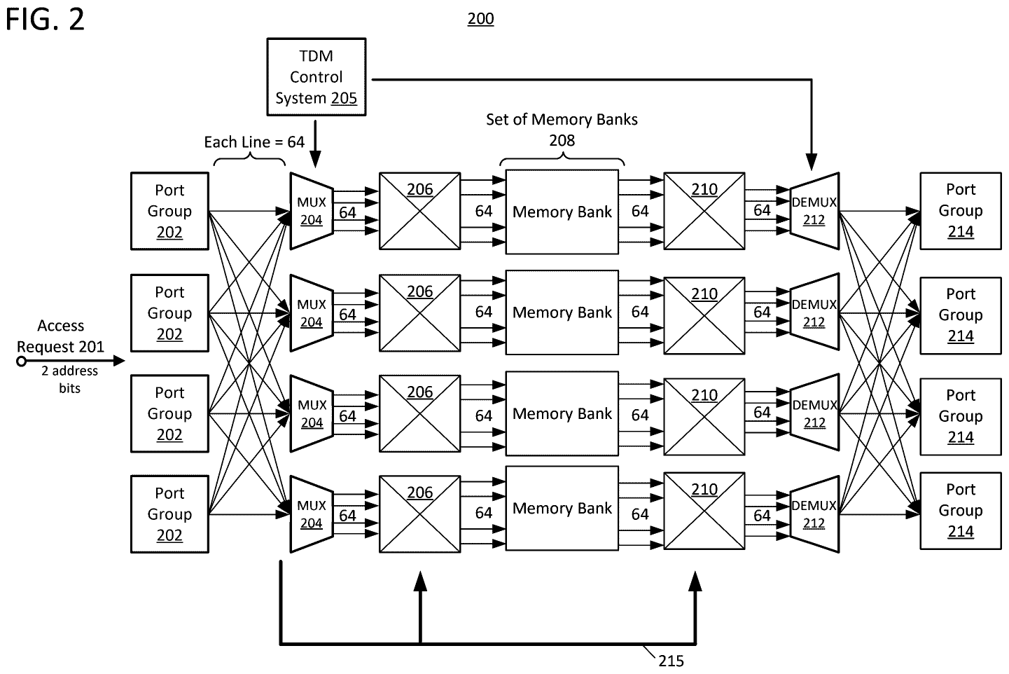

In specific embodiments of the invention, a shared memory system can include a set of port groups. The set of port groups can include groups of equal numbers of ports. For example, in shared memory system 200 shown in FIG. 2, there is a set of four equal port groups 202 with each port group having 64 ports (four each are shown) and the total set of port groups having 256 ports (sixteen total shown). Each port of the set of port groups 202 can service a client from a set of clients that share the shared memory system 200. The set of port groups 202 can receive access requests 201 from the set of clients with each client being associated with one of the ports in the set of port groups 202. The ports can be used to field a series of access requests that are delivered in parallel to the set of port groups 202. The access requests in the series of access requests can be write requests or read requests. Shared memory system 200 may include both demultiplexers and multiplexers. A demultiplexer may broadcast to multiple ports without control. A multiplexer may select one input from many inputs to output and may need a control signal.

In specific embodiments of the invention, shared memory system 200 can include a set of selection circuits. The selection circuits can be circuits which receive inputs and pass those inputs to their output based on control information received by the selection circuits. The selection circuits can be multiplexers, as shown by multiplexers 204 in FIG. 2. Each multiplexer 204 may have 64 output ports, although only four each are shown. The selection circuits can be controlled by time division multiplexing (TDM) control system 205. In specific embodiments, the TDM control system may be a time division multiple access (TDMA) control system. The selection circuits can pass one or more inputs to one or more (e.g., a subset of) outputs where the particular subset of inputs or outputs are selected based on the control inputs. The selection circuits can pass null outputs on the outputs that are not selected to receive input values. The set of port groups 202 can provide received access requests to a set of selection circuits that are coupled to the set of port groups 202 in a one-to-one correspondence.

As used herein, coupling refers to direct electronic coupling between two circuit elements such as by using a low impedance connection. For example, two circuit elements that are connected by a wire in circuit diagram can be described as being coupled. Additionally, the term coupling, as used herein, also encompasses communicative coupling between two circuit elements such that a signal on the first circuit element can be received by the second element. For example, the input of a multiplexer is coupled to the output of a multiplexer when the control signals put the multiplexer into a state which passes a signal on the input of the multiplexer to the output.

As used herein, a one-to-one correspondence between two sets refers to each element of one set uniquely corresponding with each element of the other set. For example, between the set [A, B, C] and the set [1, 2, 3] there are six potential one-to-one correspondences where one of those one-to-one correspondences is A uniquely corresponding to 1, B uniquely corresponding to 2, and C uniquely corresponding to 3.

FIG. 2 illustrates a set of port groups 202, in the form of four port groups of 64 ports each, and a set of selection circuits, in the form of four multiplexers 204, that are in a one-to-one correspondence. In the example of FIG. 2 each multiplexer 204 includes 256 outputs; each line connecting a port group 202 to a multiplexer 204 represents 64 outputs from that port group 202. Each multiplexer 204 can exhibit one of four configurations as set by the control information provided to the multiplexer 204. In each of those four configurations, a different set of 64 inputs is selected to output to routing circuits 206. In specific embodiments, a different set of 64 outputs is selected to receive the 64 input values to the multiplexer. While FIG. 2 uses the example of four different configurations, in alternative embodiments, there may be more or less than four port groups, and the selection circuits may be designed to be set into the corresponding number of configurations.

In specific embodiments of the invention, shared memory system 200 can include a set of memory banks 208. The set of memory banks 208 can include multiple memory banks that can be separately addressed. The memory banks can include individual rows or cells that can be separately addressed. The memory can store data in the memory banks that is provided from clients in an access request. The memory can retrieve and provide data from the memory banks in response to an access request. The memory can store the data in flip flops, registers, phase change materials, cross points, delay lines, or any other form of computer readable media. The set of memory banks 208 can include memory banks that are physically separate on a die or other substrate or substrates on which the shared memory system is instantiated. Alternatively, the memory banks can be in a physically contiguous region of the substrate on which the shared memory system is instantiated. The set of port groups 202, set of selection circuits (e.g., multiplexers 204), and the set of memory banks 208 can all have the same cardinality.

In specific embodiments of the invention, shared memory system 200 can include a set of routing circuits 206. Routing circuits 206 can be circuits which receive inputs and pass those inputs to their output based on control information received by the routing circuits. The set of routing circuits 206 and the set of selection circuits (e.g., multiplexers 204) can have the same cardinality. The set of routing circuits 206 can pass their inputs to their outputs in different ways depending upon their configurations. The routing circuits 206 can be designed so that they can pass any of their inputs to any of their outputs in parallel in any combination. The routing circuits 206 can be controlled by address information received by the shared memory system 200 on the ports of the shared memory in the memory access requests 201. For example, receipt of an address X on port 1 can result in a routing circuit being put in a configuration in which an input of the routing circuit associated with port 1 is routed to an output of the routing circuit coupled to a memory address associated with address X. The routing circuits can be a set of cross bar circuits. Bus 215 may represent bank address bits that control routing circuits 206 and 210.

In specific embodiments of the invention, the set of routing circuits 206 (e.g., a set of cross bar circuits) can be in a one-to-one correspondence with the set of memory banks 208. The set of port groups 202 can be coupled through the set of selection circuits (e.g., a set of multiplexers 204) and the set of routing circuits 206 (e.g., a set of cross bar circuits) in a cycle of one-to-one correspondences. The cycle of one-to-one correspondences can be controlled by TDM control system 205 or a TDMA control system. The memory banks in the set of memory banks 208 can be distinguished based on which of the routing circuits 206 they are connected to.

FIG. 2 illustrates an example of the connectivity between a set of routing circuits 206, a set of selection circuits (e.g., multiplexers 204), and a set of memory banks 208 in accordance with specific embodiments of the inventions disclosed herein. As illustrated, each memory bank in the set of memory banks 208 is coupled in a one-to-one correspondence with a routing circuit 206 from the set of routing circuits. Accordingly, there are 64 connections between each routing circuit and 64 independently addressable portions of each memory bank. Furthermore, the selection circuits are coupled in a one-to-all correspondence with the routing circuits 206. Accordingly, each multiplexer has 256 outputs with sets of 64 outputs from those 256 outputs being uniquely connected to each of the routing circuits 206. However, only one of those sets of 64 outputs of each of the selection circuits is active at a given time.

In specific embodiments of the invention, shared memory system 200 comprises TDM control system 205 (or a TDMA control system). TDM control system 205 can be coupled to a set of control inputs of a set of selection circuits such as the selection circuits mentioned above. Through this coupling to the set of control inputs, TDM control system 205 can effectuate the coupling of the set of port groups 202 through the set of selection circuits to the set of memory banks 208. With reference to FIG. 2, this involves TDM control system 205 being able to couple different port groups 202 to different memory banks through multiplexers 204 based on control information provided from TDM control system 205 to the control inputs of multiplexers 204.

In specific embodiments of the invention, TDM control system 205 can coupled, in a cycle of one-to-one correspondences, the set of port groups 202 through the set of selection circuits (e.g., multiplexers 204), to the set of memory banks 208. The coupling can be direct or conducted through alternative circuit elements such as the routing circuits 206. As illustrated in FIG. 2, the coupling can involve coupling through routing circuits 206 (e.g., a set of cross bar circuits) which route between the ports in a port group 202 and the independently addressable elements of a memory bank. In specific embodiments, this routing is done by the routing circuits using routing information in the access requests themselves while the selecting conducted by the selection circuits is conducted according to a fixed cycle which is independent of external inputs. For example, TDM control system 205 could be powered by an oscillator which cycles through a fixed pattern of one-to-one correspondences between the selection circuits in the set of selection circuits and the memory banks in the set of memory banks 208. TDM control system 205 can be an oscillator that cycles the connectivity state of the selection circuits (e.g., multiplexers 204).

The cycle of one-to-one correspondence can take various forms and be cycled in various ways. The cycle of one-to-one correspondence can be conducted in a round robin fashion such that in each phase of the cycle, each selection circuit is coupled to a different memory bank (e.g., through a routing circuit); and in the entire cycle, each selection circuit is coupled to every different memory bank. The cycle of one-to-one correspondence can cycle with a series of memory access requests to the shared memory system. Accordingly, the selection circuits can stay in a given configuration during a clock cycle, while a specific memory access request is being serviced, and can then switch to a next configuration before the next memory access request is received by the shared memory system in a next clock cycle. The TDM control system can be configured to cycle the one-to-one correspondence in lock step with the memory access requests. In specific embodiments, the cycle through the one-to-one correspondences can be fixed in accordance with a predetermined pattern that is not influenced by external information.

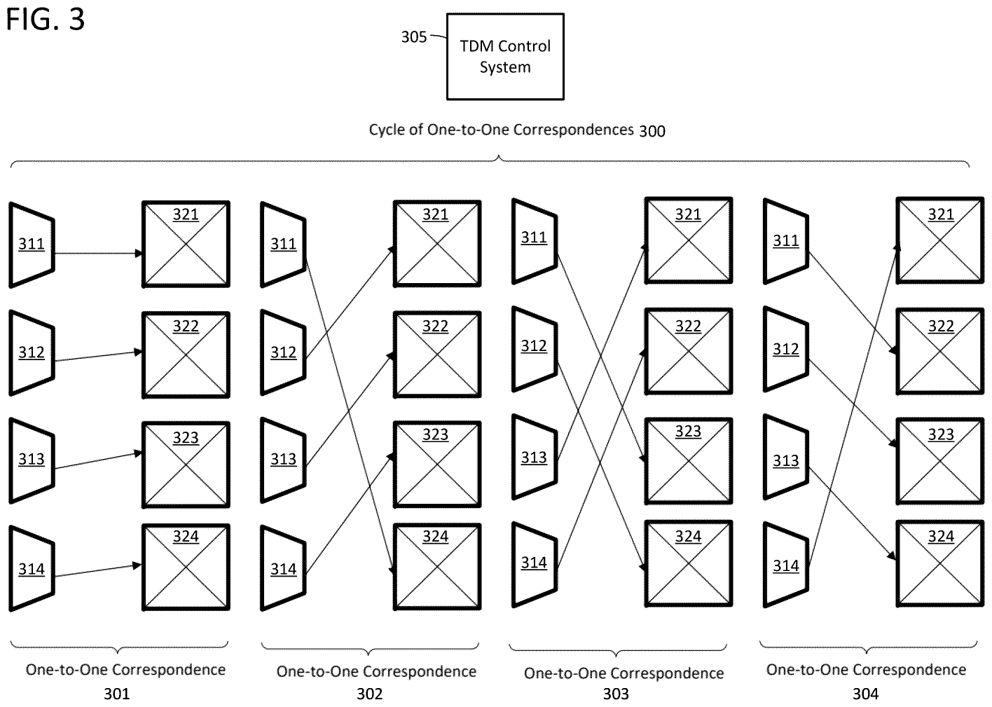

FIG. 3 provides an example of a cycle 300 of one-to-one correspondences where selection circuits 311, 312, 313, and 314 are coupled to the routing circuits 321, 322, 323, and 324 in different one-to-one correspondences based on control outputs from TDM control system 305. As seen, in each of the one-to-one correspondences 301, 302, 303, and 304, each selection circuit 311, 312, 313, and 314 is coupled to a different routing circuit 321, 322, 323, and 324, and through the entire cycle 300 of one-to-one correspondences each selection circuit 311, 312, 313, and 314 is coupled to all of the routing circuits 321, 322, 323, and 324. In accordance with FIG. 3, the selection circuits 311, 312, 313, and 314 thereby couple the different port groups to the different memory banks through the selection circuits in a given clock cycle.

In one-to-one correspondence 301, selection circuit 311 is coupled to routing circuit 321, selection circuit 312 is coupled to routing circuit 322, selection circuit 313 is coupled to routing circuit 323, and selection circuit 314 is coupled to routing circuit 324. In one-to-one correspondence 302, selection circuit 311 is coupled to routing circuit 324, selection circuit 312 is coupled to routing circuit 323, selection circuit 313 is coupled to routing circuit 322, and selection circuit 314 is coupled to routing circuit 321. In one-to-one correspondence 303, selection circuit 311 is coupled to routing circuit 323, selection circuit 312 is coupled to routing circuit 324, selection circuit 313 is coupled to routing circuit 321, and selection circuit 314 is coupled to routing circuit 322. In one-to-one correspondence 304, selection circuit 311 is coupled to routing circuit 322, selection circuit 312 is coupled to routing circuit 323, selection circuit 313 is coupled to routing circuit 324, and selection circuit 314 is coupled to routing circuit 321.

The TDM approach illustrated by FIG. 2 presents additional overhead in terms of the additional selection circuits and the circuitry for the TDM control system itself. However, when considering that the routing circuit complexity increases on a multiplicative basis with the number of inputs and outputs to the routing circuits, a comparison of FIGS. 1 and 2 presents a clear benefit to the TDM approach. The approach in FIG. 1 requires a routing circuit that is capable of 65,536 routing states. In contrast, the approach in FIG. 2, which includes the same number of ports and the same number of addressable elements in the memory banks, only requires a set of four routing circuits which are capable of 16,384 routing states in combination, which is a decrease in complexity on the order of 4. In specific embodiments, a first number of port groups, memory banks, selection circuits, and routing circuits can all be increased with the number of ports and addressable elements in the memory banks held constant to further decrease the overall complexity of the routing circuits by that first number. Given that the actual complexity of the routing circuits increases exponentially with the number of required routing states, a decrease in the number of routing states by a factor of four results in a significant improvement.

In specific embodiments, data from set of memory banks 208 may travel through additional routing circuits 210 and additional selection circuits (e.g., demultiplexers 212) to output port groups 214. Routing circuits 210 may be cross bars. In specific embodiments of the invention, both the input ports and the output ports of a multiported memory can utilize the TDM approach disclosed herein. In other words, another set of multiplexers (e.g., demultiplexers 212), which are also controlled by TDM control system 205, can couple routing circuits 210 on the output side of the set of memory banks 208 to a set of port groups 214 in a cycle of one-to-one correspondences. This cycle of one-to-one correspondence can match that of the input side selection circuits (see, for example, FIG. 3). The selection circuits (e.g., demultiplexers 212, in the output side) may have a one-to-all input coupling, a one-to-one output coupling, and various configurations which only couple one set of inputs to the output at a given time. The outputs of these selection circuits may be output connected to the set of output port groups.

In specific embodiments, a shared memory subsystem (e.g., memory system 200), may include a set of output port groups 214 and a second set of selection circuits (e.g., demultiplexers 212) coupled to the set of output port groups 214 in a second one-to-one correspondence. Furthermore, TDM control system 205 can be coupled to a second set of control inputs of the second set of selection circuits (e.g., demultiplexers 212) to couple, in a second cycle of one-to-one correspondences, the set of memory banks 208 to the set of output port groups 214 through the second set of selection circuits. This coupling can also be conducted, similarly to the coupling conducted by the first set of selection circuits, through a set of routing circuits (e.g., routing circuits 210). The set of routing circuits can be a second set of routing circuits and can be a set of cross bar circuits.

Using specific embodiments of the inventions disclosed herein, an access request may be generated by a client for a memory bank that will not be available to the client for a given number of clock cycles. For example, if the set of port groups has a cardinality of four, it is possible that a given memory bank will not be available for three clock cycles after the request is generated. Arbitration circuits may handle these requests and assure that the access request is buffered and not sent to the input port until the memory bank is accessible. The arbitration circuits can use similar logic to the logic that assures that none of the access requests received in a given cycle are directed to the same address. Indeed, the same arbitration circuits that handle that task can also handle arbitration amongst available and unavailable memory banks. Accordingly, the memory systems disclosed herein can further comprise a set of arbitrators.

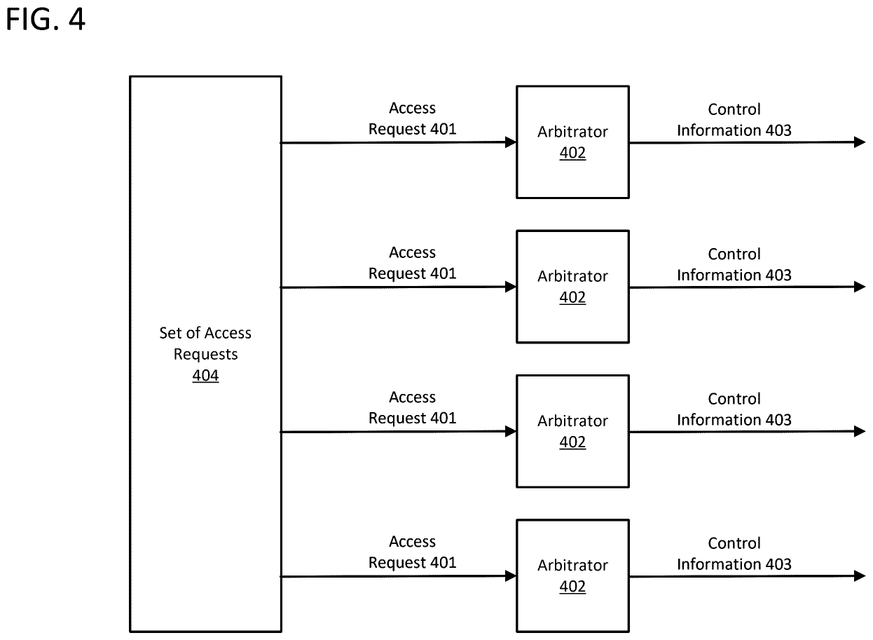

FIG. 4 illustrates a portion of a memory system with a set of arbitrators 402 in accordance with specific embodiments of the inventions disclosed herein. The set of arbitrators 402 may each uniquely receive a series of memory access requests 401 from a set of series of memory access requests 404 from clients of the memory system, and the set of arbitrators 402 can produce control information 403 for the set of routing circuits described herein, as well as buffering memory access requests for memory banks that are not available based on the cycle of the memory system.

The shared memory system may comprise a set of arbitrators that each uniquely receive a series of memory access requests from a set of series of memory access requests from clients of the memory system. Each arbitrator may be associated with a specific subset of the client ports and may handle arbitration decisions for that subset independently of other arbitrators. The arbitrators may implement sophisticated scheduling algorithms that consider factors such as request age, client priority, and bank availability when making arbitration decisions. The arbitrators may also implement anti-starvation mechanisms that prevent any single client from being indefinitely blocked by higher-priority or more frequent requests from other clients. The set of arbitrators may produce control information for the set of cross bar circuits, where the control information includes routing decisions, timing information, and conflict resolution data that configures the cross bar circuits to properly route requests to their intended memory banks. An arbitration system may balance timing optimization against latency distribution characteristics. The arbitration may occur at multiple levels within the system, including arbitration between different client groups for superbank access and arbitration within each superbank for individual bank access.

Arbitrators 402 and logic of FIG. 4 can assure that there are no requests sent to the memory system while the memory system is unable to service them. Buffering the request for a number of clock cycles may improve serviceability; however, the logic may not solve the problem of increased latency for servicing the access requests while waiting for a desired memory bank to become available. This issue can be alleviated through the use of data swizzling in which data is stored across the memory banks in a pattern that makes it more likely the data will be available. In accordance with this approach, contiguous data in the application layer of a computation being conducted by clients of the shared memory system can be stored in keeping with the cycle of the shared memory. For example, if the application layer referred to data at addresses in the form of x, x+y, x+2y, and x+3y where y was the size of the independently addressable data elements used by the application layer, those three data elements could be stored across four different memory banks such that they would be available in four consecutive phases of the cycle of the shared memory.

In specific embodiments of the inventions disclosed herein, data swizzling can be conducted based on the addressing scheme of the shared memory with contiguous addresses being mapped to disparate memory banks in a pattern that follows the cycle of the shared memory system. In such an example, a client of a shared memory system could sequentially access contiguously addressed data in the shared memory system, and the contiguously addressed data can be distributed in the memory banks in accordance with the cycle of one-to-one correspondences.

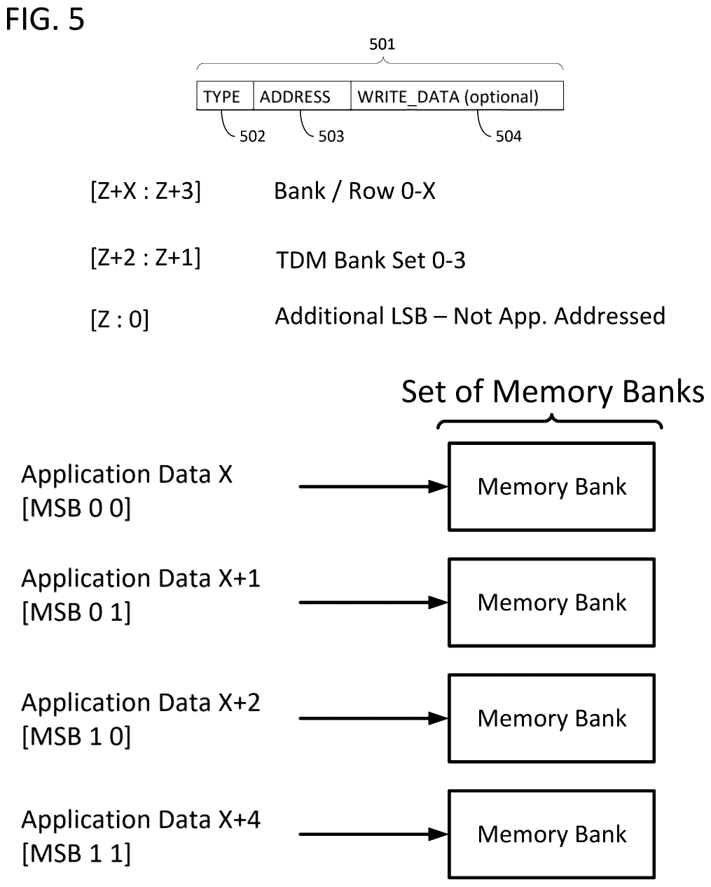

FIG. 5 provides an example of an addressing scheme and data swizzling in a shared memory that is in accordance with specific embodiments of the inventions disclosed herein. Memory access request 501 may include header 502, which may identify the type of the access request as either a write request or a read request. Memory access request 501 may also include address 503, to which access request 501 refers, and optional data 504 that can be included if the access request is a write request. The write data can be 16 bytes wide, the read data from the memory can be 16 bytes wide, and the input ports can be larger to account for the type and address information. Alternatively, the read data can include additional program data that uses this space and the ports can be the same size. Regardless, the addressing scheme can be set such that the least significant bits of the address, which are not associated with data elements that are not independently addressable, can select the bank of the shared memory. Bits Z+2 to Z+1 may refer to TDM bank set 0-3 (e.g., a superbank).As illustrated, bits Z+2 to Z+1, where Z:0 are bits that refer to data elements that are not independently addressable by the shared memory, encode the identity of the bank of the shared memory in which the data is stored. Accordingly, there can be four memory banks in the set of memory banks. The remaining MSBs of size X+1 can then refer to the specifically addressable memory elements within the bank. Bits Z+X to Z+3 may refer to bank/row 0-X. Using this addressing scheme, a series of requests with respect to contiguously addressed data from the shared memory by a given input port will not experience any latency regardless of the fact that the port only has access to a limited number of memory banks during any given phase of the cycle of the shared memory.

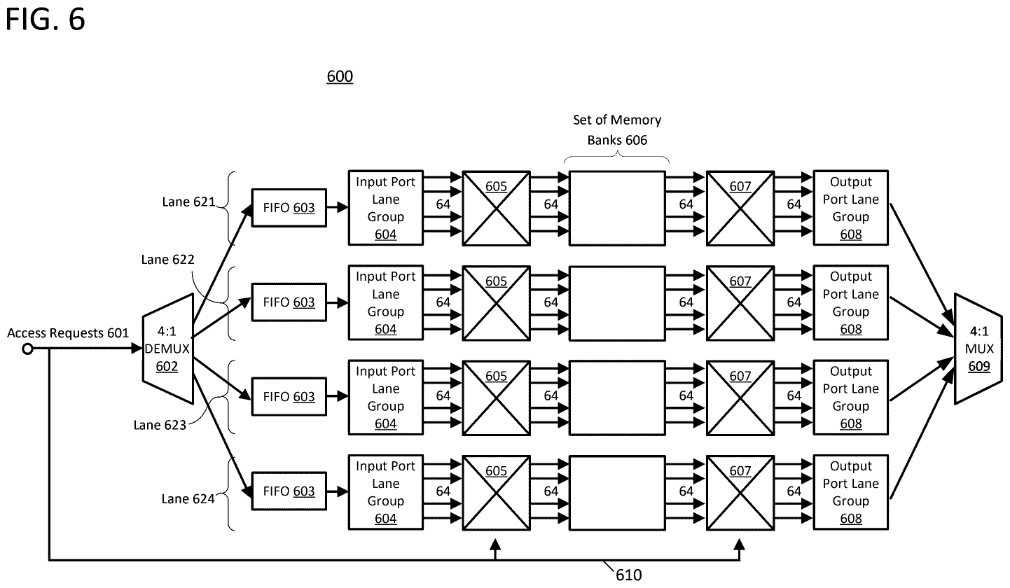

FIG. 6 illustrates lane access division to different banks or sub-banks in a shared memory system in accordance with specific embodiments of the inventions disclosed herein. Creating lanes is a way to make the routing circuits (e.g., cross bars) simpler. In this approach, certain ports are associated with certain lanes. FIG. 6 shows four lanes, although a memory system may include any quantity of lanes. Ports are physical inputs that receive access requests. Lanes refer to the fact that only a portion of a memory bank is reserved for an access from those ports. Since a given port may only connect to the memory addresses associated with its lane, there is less connectivity needed between the ports and the memory banks. In specific embodiments, access requests may be sorted into the correct port group based on their lane. Because access requests can only be completed in certain lanes, the lanes may limit the bandwidth of the memory in some instances. However, the lanes may be configured to minimize the instances where the bandwidth may become limited.

Shared memory system 600 may include a set of memory banks 606, a set of cross bar circuits 605, and selection circuitry (e.g., demultiplexer 602). Each cross bar circuit 605 may be uniquely coupled with a memory bank of the set of memory banks 606. The selection circuit may be selectively coupled to each cross bar circuit 605. The selection circuit may route access request 601 to a cross bar circuit 605 based on one or more bits of a memory address of access request 601. Any address bit may be selected to determine a lane for the access request. In specific embodiments, the access request may be routed based on one or more least significant bits of a memory address of the access request. The least significant bits may toggle more often, which may provide better coverage and performance for dividing memory access requests for contiguous memory locations. Bus 610 may represent bank address bits that control cross bars 605 and 607.

Selection circuitry may sort access requests into lanes based on the LSB of each access request (e.g., the LSBs of a memory address portion of the address request). Because data is usually accessed sequentially, the memory system may often be able to use every lane. For example, a client may request data with LSBs 00, 01, 10, and 11; the memory system may service all of the requests in one time step using four lanes (0, 1, 2, 3). Although FIG. 6 depicts four lanes, a memory system may be divided into any quantity of lanes. For example, the memory system may be divided into eight lanes and may use three LSBs of a memory address to sort access requests. As another example, the memory system may be divided into two lanes and may use one LSB of a memory address to sort access requests.

In the example of FIG. 6, shared memory system 600 has four lanes 621, 622, 623, and 624. Demultiplexer 602 (e.g., a selection circuit) may sort access request 601 into either lane 621, lane 622, lane 623, or lane 624 based on the two LSB of the memory address of the access request. Demultiplexer 602 may be a 4:1 multiplexer. Each lane may operate similarly but may access a different memory bank of the set of memory banks 606. Each lane may include a first-in-first-out (FIFO) buffer 603. Buffers 603 may ensure that the memory system has time to complete each request.

In the example of FIG. 6, demultiplexer 602 may include 256 outputs total such that each line connecting demultiplexer 602 to an input port lane group 604 represents 64 outputs from demultiplexer 602. While FIG. 6 uses the example of a 4:1 demultiplexer, in alternative embodiments, there may be more or less than four lanes and the selection circuit may be designed accordingly.

In specific embodiments of the invention, shared memory system 600 can include a set of routing circuits 605. Routing circuits 605 can be circuits which receive inputs and pass those inputs to their output based on control information received by the routing circuits. The set of routing circuits 605 can pass their inputs to their outputs in different ways depending upon their configurations. The routing circuits 605 can be designed so that they can pass any of their inputs to any of their outputs in parallel in any combination. The routing circuits 605 can be controlled by address information received by the shared memory system 600 on the ports of the shared memory in the memory access requests 601. For example, receipt of an address X on port 1 can result in a routing circuit being put in a configuration in which an input of the routing circuit associated with port 1 is routed to an output of the routing circuit coupled to a memory address associated with address X. The routing circuits can be a set of cross bar circuits.

In specific embodiments of the invention, shared memory system 600 can include a set of memory banks 606. The set of memory banks 606 can include multiple memory banks that can be separately addressed. The memory banks can include individual rows or cells that can be separately addressed. The memory can store data in the memory banks that is provided from clients in an access request. The memory can retrieve and provide data from the memory banks in response to an access request. The memory can store the data in flip flops, registers, phase change materials, cross points, delay lines, or any other form of computer readable media. The set of memory banks 606 can include memory banks that are physically separate on a die or other substrate or substrates on which the shared memory system is instantiated. Alternatively, the memory banks can be in a physically contiguous region of the substrate on which the shared memory system is instantiated. In specific embodiments, the set of port groups 604, set of routing circuits 605, and the set of memory banks 606 can all have the same cardinality.

Routing circuits 607 may receive outputs from set of memory banks 606 according to their lanes and may organize the outputs according to output port lane groups 608. Multiplexer 609, which may be 4:1 multiplexers, may combine output port lane groups 608 of lanes 621, 622, 623, and 624 back together. In specific embodiments, the set of routing circuits 607, set of port groups 608, and the set of memory banks 606 can all have the same cardinality.

The lane access system may dramatically decrease the complexity of a cross bar. In a banked memory system, the cross bar (which connects ports to banks) can become very large and complex. For example, a system with 256 ports and 256 banks, each with a 128-bit data width, has a cross bar complexity that grows with the square of the number of ports and banks (approximately N×(M-1) where N=M=256). With lane access, the data bus width may be increased (e.g., by four times if there are four lanes). The cross bar size may be significantly reduced by increasing the data bus width. Instead of a single 256×256 cross bar for 128-bit data, the memory system can use four smaller cross bars, each handling 128-bit data and connecting 64 ports to 64 banks. This reduces the cross bar complexity by approximately four times (N=64,M=64). The two least significant bits (LSBs) of the address may determine which of the four 128-bit “lanes” a request is sent to. On the input side, requests from different ports may be pre-sorted into the appropriate lanes (e.g., using FIFO buffers). This may require a 4:1 multiplexing operation. On the output side, read data returning from the lanes may be multiplexed back to their original 128-bit port. This also may require a 4:1 multiplexing operation. Even with the added complexity of the 4:1 multiplexers for sorting requests and redirecting responses, the O(N \hat{ }2) reduction in cross bar size is much more significant.

The lane access technique and the TDM access technique may have compounded benefits when combined (although they can be used independently). For example, the TDM access technique may provide a four times cross bar reduction. The lane access technique may provide an additional four times cross bar reduction. When used together, the lane access technique and the TDM access technique may provide a 16 times cross bar reduction. For example, a 256-port×256-bank×128-bit cross bar can be reduced to 16 much smaller 16×16 cross bars.

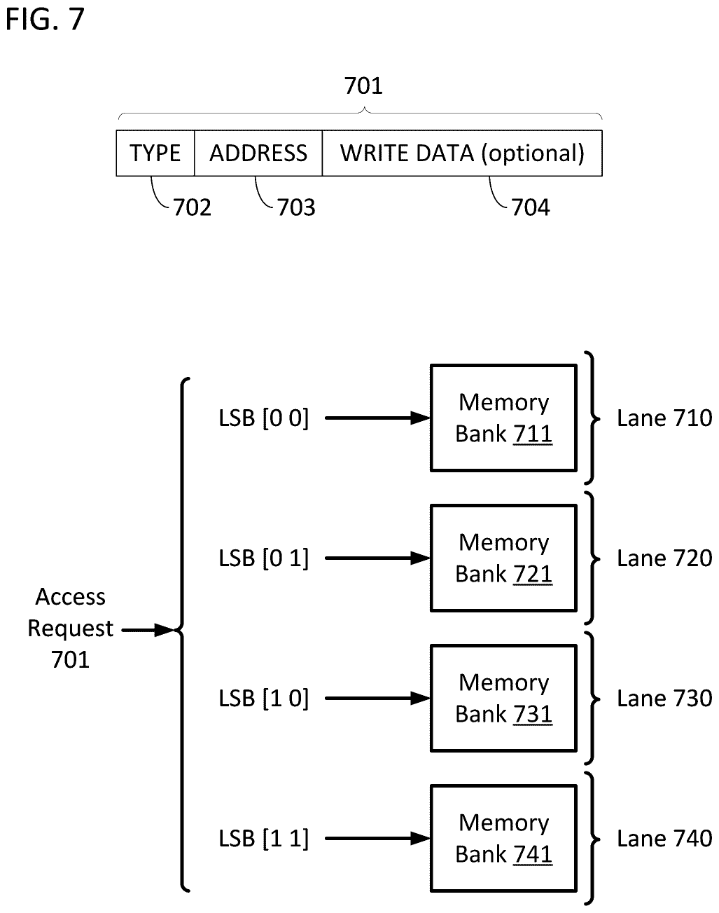

FIG. 7 illustrates an example of an addressing scheme and data swizzling in a shared memory using lane access that is in accordance with specific embodiments of the inventions disclosed herein. Memory access request 701 may include header 702, which may identify the type of the access request as either a write request or a read request. Memory access request 701 may also include address 703, to which access request 701 refers, and optional data 704 that can be included if the access request is a write request. The write data can be 16 bytes wide, the read data from the memory can be 16 bytes wide, and the input ports can be larger to account for the type and address information. Alternatively, the read data can include additional program data that uses this space and the ports can be the same size. Regardless, the addressing scheme can be set such that the least significant bits of the address can select the memory system lane, and thus the bank or sub-bank of the shared memory. In the example of FIG. 7, there can be four memory banks in the set of memory banks. If the LSBs of address 703 of access request 701 are 0,0 then access request 701 may be processed in lane 710 and may access memory bank 711. Similarly, if the LSBs of address 703 are 0,1; 1,0; or 1,1 then access request 701 may be processed in lane 720, lane 730, or lane 740 respectively and may access corresponding memory banks 721, 731, and 741. The remaining address bits can then refer to the specifically addressable memory elements within the corresponding bank. In specific embodiments, access requests may correspond to contiguously addressed data. Using this addressing scheme, the chances that a bottleneck for accessing a single memory bank are decreased, regardless of the fact that each memory bank may only be accessed using one lane.

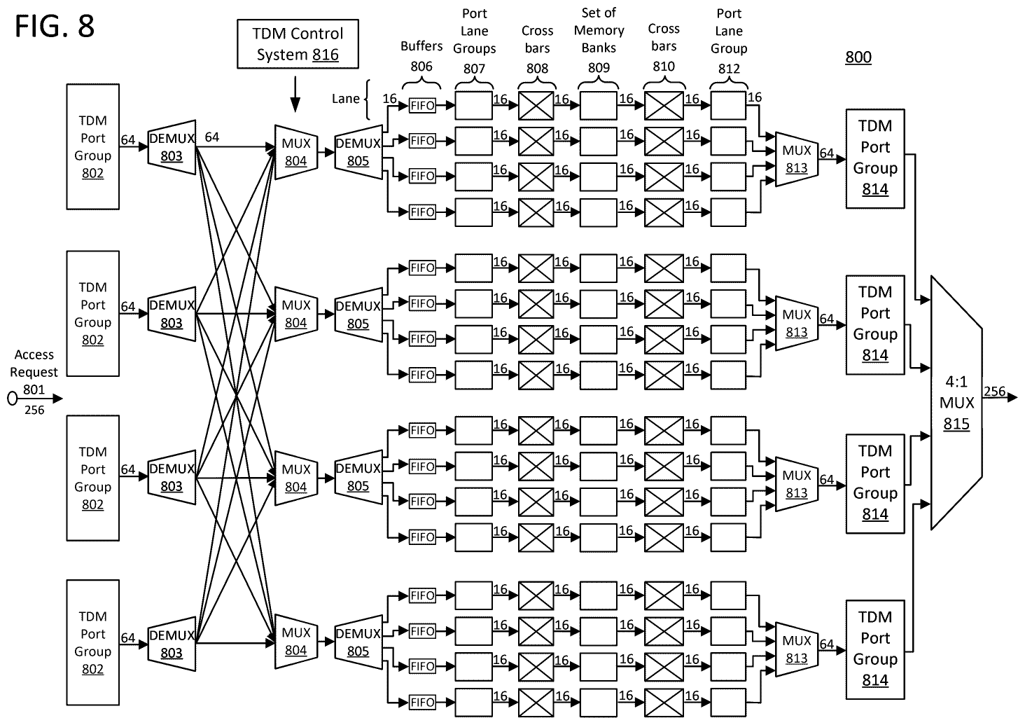

FIG. 8 illustrates a conceptual diagram of a shared memory system that uses lane division access inside time division to decrease complexity of routing circuitry in accordance with specific embodiments of the inventions disclosed herein. In the example of FIG. 8, 256 sub-ports may attempt to access 256 sub-banks. Using TDM, both the sub-ports and sub-banks are divided by four into four client groups and four superbanks respectively. The four client groups of TDM port groups 802 may rotate amongst four superbanks (e.g., via demultiplexers 803) each cycle or four sets of 64 clients trying to access 64 SRAMs each cycle.

Shared memory system 800 may be a client port interface architecture that provides enhanced memory access capabilities through a multi-lane structure and time division multiplexing. System 800 receives access requests (such as access request 801) and distributes them to TDM port groups 802. Each TDM port group 802 may have 64 ports and the total set of port groups may have 256 ports. Demultiplexers 803 may operate similarly to multiplexers 204. Demultiplexers 803 may be selection circuits and receive inputs and pass those inputs to their output based on control information received by the selection circuits. Demultiplexers 803 may output the access request signals, or information about the access request signals, to each multiplexer 804 at different times. Multiplexers 804 (e.g., selection circuits) can be controlled by TDM control system 816 and may be TDM multiplexers that operate back to back with lane demultiplexers 805. Each demultiplexer 805 may divide the incoming requests across four separate lanes, with each lane operating independently to maximize throughput and minimize blocking conditions.

Each lane grouping may take (via demultiplexers 805) the 64 SRAMs (e.g., sub-banks) in each superbank as a starting point and divide them, based on two bits of their address, into four lanes with 16 SRAMs in each. Demultiplexers 805 may be 4:1 demultiplexers. Each lane may include a dedicated first-in-first-out (FIFO) buffer 806 that accumulates access requests, allowing the system to handle varying request rates and timing requirements across different lanes. FIFO buffers 806 may be configured with specific depth parameters to accommodate off-cycle superbank accesses and provide sufficient buffering capacity for maintaining high utilization rates. The lane-based architecture enables the flex client port interface to provide independent access ports to a specific bank within the shared memory system.

Set of memory banks 809 may be organized into subsets of memory banks. A set of memory banks may refer to banks accessible from a TDM port group 802 while subsets of banks may refer to portions of the banks that are accessible to a lane (e.g., port lane group 807) within that TDM port group 802. Each subset of each memory bank may comprise a group of memory addresses that have at least one memory address bit in common; this way, memory access requests may be sorted by that address bit. TDM port groups 802 may include or correspond to port lane groups 807 (e.g., subsets of the port group). Each port lane group 807 may correspond to a subset of a memory bank in a one-to-one correspondence. Port lane groups 807 may route memory access request 801 based on one or more least significant bits of a memory address of memory access request 801. Port lane groups 807 may route memory access request 801 to the corresponding subset of a memory bank (e.g., of set of memory banks 809) based on one or more least significant bits of a memory address of memory access request 801.

In the architecture of FIG. 8, each cross bar 808 may route 16 requests for 16 SRAMs. The corresponding memory bank in the set of memory banks 809 may be accessed. Cross bars 810 may handle the output routing from set of memory banks 809, directing read data and response signals back toward the client ports. Cross bars 810 may have routing capabilities between 16 inputs and 16 outputs within each cross bar unit. The data from the access requests may be organized into port lane groups 812. Multiplexers 813, which may be 4:1 multiplexers, may combine the lanes back to TDM port groups 814. Multiplexer 815 may combine TDM port groups 814 together. In specific embodiments, multiplexers 813 and multiplexer 815 may be combined. In specific embodiments, multiplexer 815 may combine the output TDM port groups 814 to provide the final output interface for the shared memory system, completing the data path from memory banks back to the requesting clients.

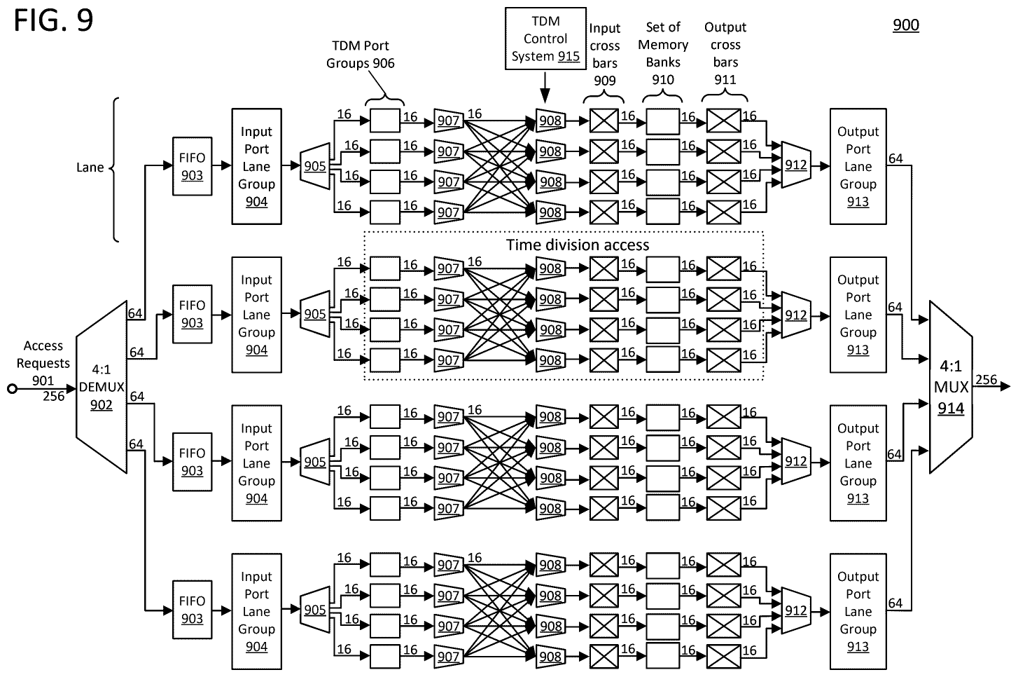

FIG. 9 illustrates a conceptual diagram of a shared memory system that uses time division inside lane division access to decrease complexity of routing circuitry in accordance with specific embodiments of the inventions disclosed herein. In the example of FIG. 9, 256 sub-ports may attempt to access 256 sub-banks. Each lane grouping may take (via demultiplexer 902) 64 SRAMs based on two bits of their address. Demultiplexer 905 may divide the client lane groups by four, creating four TDM port groups 906 within each lane and sixteen TDM port groups 906 total.

Access request 901 may be processed through demultiplexer 902, which distributes requests based on address information to appropriate lanes within the system. Each lane may handle a portion of the set of memory banks 910, with FIFO buffers 903 providing buffering capabilities to manage request timing and flow control. Input port lane groups 904 may organize the ports within each lane to facilitate efficient routing to the memory banks.

Each demultiplexer 905 may divide the client lane groups into four sections, creating four TDM port groups 906 within each lane for a total of sixteen TDM port groups across the system. Each TDM port group 906 may contain a subset of the total client ports, allowing for organized access patterns and efficient arbitration. Each TDM port group 906 may route to a multiplexer 907, which then routes to multiplexers 908 that are controlled by TDM control system 915. At different times, each multiplexer 908 within a lane may route from a multiplexer 907 within that lane to an input cross bar 909 and may include 16 SRAMs in each.

Multiplexer 908 may be controlled by TDM control system 915 to route signals from TDM port groups 906 to the appropriate input cross bars 909 based on the time division multiplexing cycle. Each cross bar 909 may route 16 requests to 16 SRAMs within set of memory banks 910, providing a manageable complexity level while maintaining high connectivity. The choice between cross bar implementations may depend on the specific timing constraints and physical layout requirements of the memory system. In this architecture, each cross bar may route 16 requests for 16 SRAMs. The cross bar circuits in shared memory system 900 may be implemented as 16×16 cross bars, providing routing capabilities between 16 inputs and 16 outputs within each cross bar unit.

Cross bars 911 may handle the output routing from set of memory banks 910, directing read data and response signals back toward the client ports. Multiplexers 912 may organize the output signals into output port lane groups 913, with each multiplexer potentially implemented as a 4:1 multiplexer to combine signals from the four lanes within each group. In specific embodiments, multiplexers 912 and multiplexer 914 may be combined. In specific embodiments, multiplexer 914 may combine the output port lane groups 913 to provide the final output interface for the shared memory system, completing the data path from memory banks back to the requesting clients.

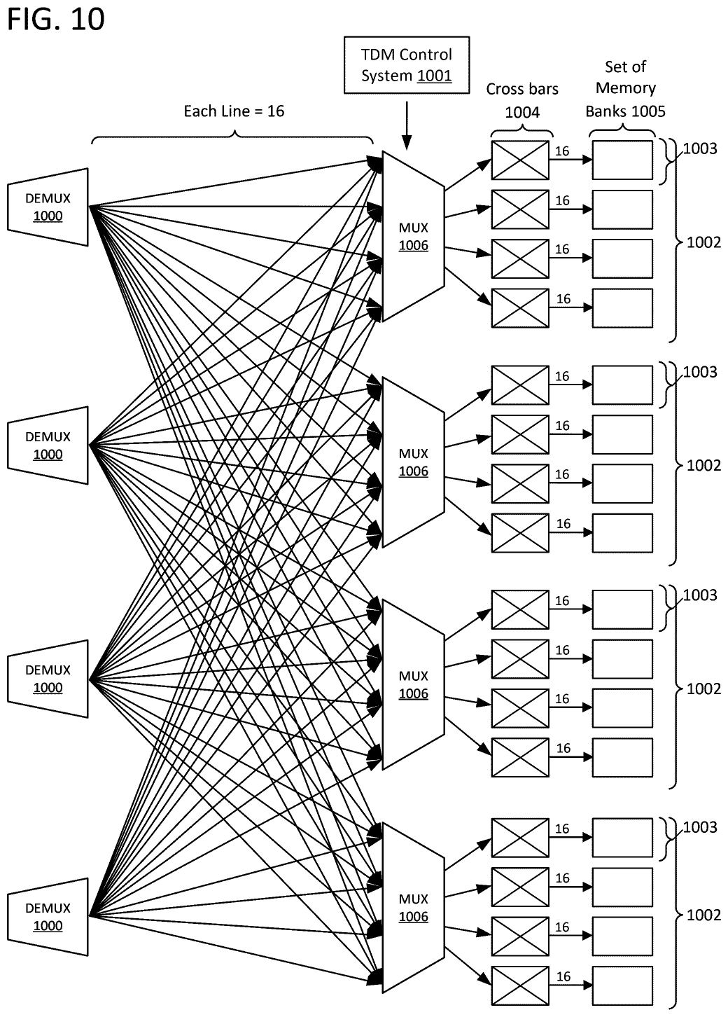

FIG. 10 illustrates an example of multiplexers of a shared memory system dividing access requests using both lane division and time division in accordance with specific embodiments of the inventions disclosed herein. Demultiplexers 1000 output access requests into sixteen discrete groups. Multiplexers 1006 organize the access requests into one of four TDM groups 1002 according to TDM control system 1001. Multiplexers 1006 organize the access requests into lanes 1003 according to the address bits of the access requests. The LSBs of the memory address may identify both the lanes and the banks (e.g., with four LSBs, the memory system can identify four lanes and four banks). Multiplexers 1006 may simultaneously organize access requests according to lane division and time division.

In the example of FIG. 10, 256 sub-ports attempt to access 256 sub-banks within set of memory banks 1005. Using time division access, both the sub-ports and sub-banks are divided by four into four client groups and four superbanks respectively, such that four client groups of sub-ports TDM are rotating amongst four superbanks each cycle or four sets of 64 clients trying to access 64 SRAMs each cycle. The lanes may take the 64 SRAMs (e.g., sub-banks) in each superbank as a starting point and divide them into four lanes with 16 SRAMs in each. Each arrow in FIG. 10 may represent 16 SRAMs. Simultaneously, all of the requests from sets of four sub-ports within a flex client may be combined and placed in one of four buffers (e.g., FIFO) in restricted lanes based on two bits of their address, such that a cross bar 1004 receives 16 requests for 16 SRAMs. Access requests may be divided into lanes before they are issued to a particular superbank. The lane division and time division methods of reducing routing circuitry complexity are independent and can be used independently or combined (as in FIGS. 8-10). The sorting into lanes and superbanks can occur in either order or simultaneously (e.g. one request routed to one of 16 FIFO buffers that represent a specific superbank or lane).

In specific embodiments, buffers in each lane and/or TDM group may hold access requests until the circuitry is able to process them. In specific embodiments, additional FIFO layers beyond basic lane buffers may further avoid head-of-line blocking and improve overall system performance. These additional buffering layers may be positioned at various points within the interface to accommodate different timing requirements and access patterns. The multi-level buffering approach allows the system to handle complex access scenarios where different lanes may experience varying latencies or where certain memory banks may be temporarily unavailable due to the time division multiplexing cycle. The interface may also include control mechanisms that manage the flow of requests and responses between the different buffering levels, ensuring optimal utilization of the available bandwidth while maintaining the ordering and timing requirements of the memory system.

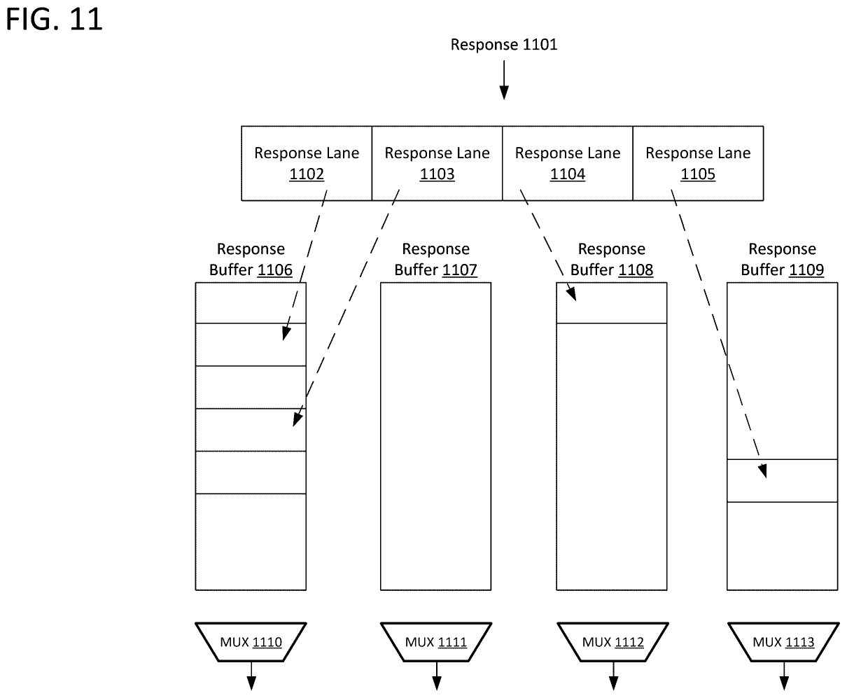

FIG. 11 illustrates a response buffer system in accordance with specific embodiments of the inventions disclosed herein. The response buffer system in FIG. 11 includes multiple buffer entries that can receive data from any of the four lanes through a sophisticated multiplexing arrangement. Each buffer entry may be coupled to all four lanes through dedicated 4:1 multiplexers, allowing responses from any lane to be stored in any available buffer entry. This flexible routing capability prevents head-of-line blocking conditions that could otherwise occur if responses were restricted to specific buffer locations based on their originating lane. The response buffer entries may be managed through control logic that tracks the order in which requests were originally submitted, ensuring that responses can be delivered in the correct sequence regardless of the order in which they complete processing. The multiplexing logic associated with each buffer entry may provide connectivity to route responses from the appropriate lane to the designated buffer location based on the response management system's tracking information.

One or more output multiplexers may select from the available response buffer entries to provide responses in the correct order, maintaining the in-order response delivery capability even when requests are processed out of order across the different lanes. The response buffer management system may include tracking mechanisms that monitor the status of each buffer entry and coordinate the selection process to ensure proper response sequencing. In some cases, the response buffer may implement a reorder FIFO block functionality that maintains response ordering even when reads and writes occur out of order across the multiple lanes. The control logic may manage the allocation of buffer entries, the routing of responses through the 4:1 multiplexers, and the selection of completed responses for output delivery. This architecture allows the flex client port interface to achieve higher throughput by enabling parallel processing across multiple lanes while preserving the ordering requirements that may be necessary for proper system operation.

FIG. 11 illustrates a shared memory system with response buffers to enhance system reliability, performance, and support for complex memory operations. Response 1101 may be sent to response lane 1102, response lane 1103, response lane 1104, or response lane 1105. A response lane may also be considered a register. In specific embodiments, the response lane that response 1101 is sent to may be based on which lane output the response or may be based on the associated access request. Logic may organize responses stored in the response lanes to slots in response buffers 1106, 1107, 1108, and 1109. A response buffers may be a response buffers for an interface. The slots may be reserved for specific responses based on the corresponding access requests of the responses. Multiplexers 1110, 1111, 1112, and 1113 may output the responses from response buffers 1106, 1107, 1108, and 1109. The response lanes, response buffers, interfaces, and multiplexers may allow access requests and responses to be matched and ordered despite the varying completion times and parallel processing of the requests. In specific embodiments, the shared memory system may support serialized in-order access for some memory regions and may allow out-of-order completion for other memory regions.

The combined ports of a memory subsystem may output 512 bits. However, the bits may be separated according to access requests performed by separate lanes. The outputs of the lanes may go to a response buffer. The response buffer may organize the outputs with their corresponding access requests.

The access requests and responses may be confined to a single lane. Different access requests may take different amounts of time to execute. A multiplexer may combine the output data from the different lanes into a single wire. When the lane outputs are combined, they may combine out of order due to the different access requests taking different amounts of time in the parallel execution. Logic may direct each response into a response buffer slot. Each response buffer slot may be tagged with a specific access request and may receive the corresponding response. A multiplexer may be in front of the entry to the response buffer. Any of the entries can be written in any cycle. The access requests may be completed out of order and each access request may have a specific spot reserved for them in the response buffer, such that the shared memory system is able to reorder the responses according to the corresponding access requests. Logic may direct a response into a particular entry through a multiplexer (e.g., a 4:1 MUX). To get the data out of the response buffer, there may be a multiplexer at the bottom of the response buffer that takes all of the possible entries and selects one of them out. The shared memory system may include logic to serve the responses such that the responses are served in order (e.g., in the order of the access requests).

Once a lane outputs a response, the memory system may sort the response into one of four interfaces. In specific embodiments, a request and a response may contain four lanes of 128 for the same interface. In a single cycle, four responses may be popped from the same lane. Separate FIFO buffers may return and aggregate responses per lane. Lanes may be allocated separately to avoid blocking and avoid counting remaining responses to be popped. In specific embodiments, space may be allocated on issue to keep buffers small. In specific embodiments, space may not be allocated earlier than issue because up to four lanes operating in parallel may need allocated space.

A response entry table may manage and direct the response buffers. The response entry table may not need lane information, since lanes may never overlap. However, the response entry table may need four write ports for corner cases when all four lanes are from the same interface (e.g., duplicate four times). A response buffer per interface (e.g., sub-port) may avoid potential hogging compared to a shared buffer.

If a client order is twice the size of the response buffer, then a response buffer slot may be assigned at a push request for the interface. The client order most significant bit (MSB) may be dropped and low order bits may point to a response buffer destination index. In specific embodiments, this may remove the need for some tables and buffers as the client order may be used directly.

An issue window may keep track of which client orders can issue per interface. The issue window may be implemented as a shiftable 16 bit vector with 8 bits set to 1 and other bits set to 0. If a response pops, then the issue window may shift one to the left. In specific embodiments, deadlock may be avoided since in-order response at the head may be guaranteed space first. An arbitrator may use an issue window to block one or more requests until the response destination is available. The memory system may include a response buffer per interface with four write ports to potentially receive responses from all four lanes.

The number of banks and the number of superbanks are configurable. The lane access and time division access concepts are scalable. The larger the number of banks, the smaller the cross bar may be, but the more restrictive the access may become and the more arbitration may be required. There may be a tradeoff between minimizing the cross bar and having good performance. As discussed herein, there are ways to reduce the likelihood of poor performance even with decently small cross bars.

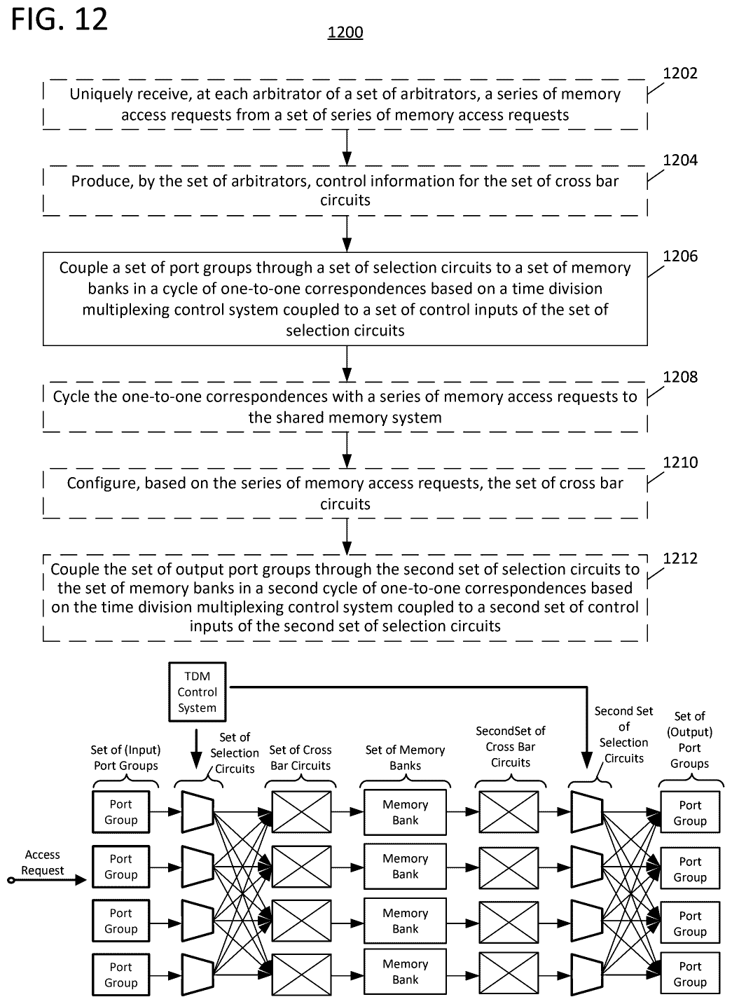

FIG. 12 provides an example of method 1200 of operating a shared memory system using time division multiplexing in accordance with specific embodiments of the inventions disclosed herein. Method 1200 may be implemented by a system including a set of port groups, a set of selection circuits coupled to the set of port groups in a one-to-one correspondence, a set of memory banks, and a time division multiplexing control system. In specific embodiments, the system may also include a set of cross bar circuits, a set of arbitrators, a set of output port groups, and a second set of selection circuits. Method 1200 may be implemented by a system including a non-transitory computer-readable medium having instructions stored thereon, that when executed by one or more processors, cause the one or more processors to perform operations of method 1200. Method 1200 may be implemented by a system including means for performing the steps of method 1200. Steps, or portions of steps, of method 1200 may be duplicated, omitted, rearranged, or otherwise deviate from the form shown. Additional steps may be added to method 1200. Steps, or portions of steps, of method 1200 may be performed in series or parallel.

In specific embodiments, at step 1202, a series of memory access requests may be uniquely received at each arbitrator of a set of arbitrators. The series of memory access requests may be uniquely received from a set of series of memory access requests.

In specific embodiments, at step 1204, control information for the set of cross bar circuits may be produced by the set of arbitrators. In specific embodiments, the set of cross bar circuits may be in a one-to-one correspondence with the set of memory banks.

At step 1206, the set of port groups may be coupled through a set of selection circuits to the set of memory banks in a cycle of one-to-one correspondences based on the time division multiplexing control system coupled to a set of control inputs of the set of selection circuits. The set of selection circuits may be coupled to the set of port groups in a one-to-one correspondence. In specific embodiments, the set of port groups may be coupled through the set of selection circuits and the set of cross bar circuits in the cycle of one-to-one correspondences. In specific embodiments, the set of port groups may be a set of input port groups. In specific embodiments, the set of selection circuits may be a set of multiplexers. The time division multiplexing control system may be an oscillator that cycles the connectivity state of the multiplexers. In specific embodiments, each port of the set of port groups may service a client from a set of clients that share the shared memory system.

In specific embodiments, at step 1208, the one-to-one correspondences may cycle with the series of memory access requests to the shared memory system.

In specific embodiments, at step 1210, the set of cross bar circuits may be configured based on the series of memory access requests.

In specific embodiments, at step 1212, the set of output port groups may be coupled through the second set of selection circuits to the set of memory banks in a second cycle of one-to-one correspondences based on the time division multiplexing control system coupled to a second set of control inputs of the second set of selection circuits. The second set of selection circuits may be coupled to the set of output port groups in a second one-to-one correspondence.

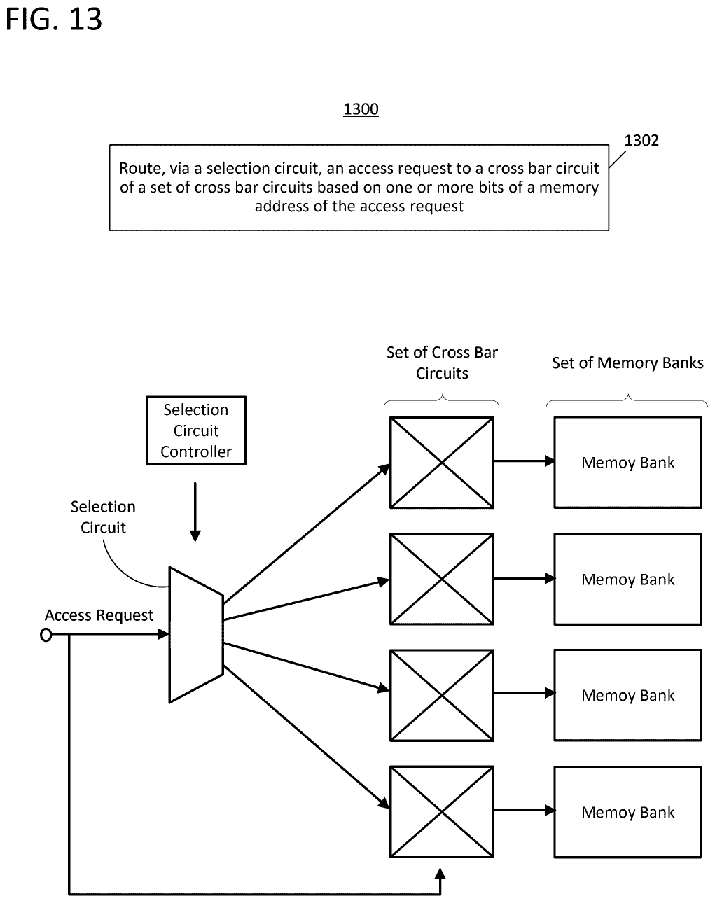

FIG. 13 provides an example of method 1300 of operating a shared memory system using lane access in accordance with specific embodiments of the inventions disclosed herein. Method 1300 may be implemented by a system including a set of memory banks, a set of cross bar circuits, and a selection circuit. In specific embodiments, the system may also include a set of arbitrators, a set of input port groups, a set of output port groups, and a second selection circuit. Method 1300 may be implemented by a system including a non-transitory computer-readable medium having instructions stored thereon, that when executed by one or more processors, cause the one or more processors to perform operations of method 1300. Method 1300 may be implemented by a system including means for performing the steps of method 1300. Additional steps may be added to method 1300 including steps of method 1200. Method 1200 and method 1300 may be performed by the same system.

At step 1302, an access request may be routed, via a selection circuit, to a cross bar circuit of a set of cross bar circuits. The access request may be routed based on one or more bits of a memory address of the access request. Any address bit may be selected to determine a lane or superbank (e.g., TDM bank) for the access request. In specific embodiments, the access request may be routed based on one or more least significant bits of a memory address of the access request. The least significant bits may toggle more often, which may provide better coverage and performance for dividing memory access requests for contiguous memory locations. The selection circuit may be selectively coupled to each cross bar circuit of the set of cross bar circuits and each cross bar circuit may be uniquely coupled with a memory bank of a set of memory banks.

Lane access and time division provide significant benefits for multiported memory systems by dramatically reducing the complexity and cost associated with routing circuitry while maintaining high performance and scalability. By implementing time division multiplexing techniques that cycle port groups through different memory banks in predetermined patterns, the system may achieve a substantial reduction in routing complexity. The disclosed systems may enable the practical implementation of multiported memories without incurring the prohibitive complexity and cost penalties that would otherwise result. Additional techniques such as lane access and data swizzling may further enhance system performance by reducing bottlenecks and ensuring optimal bandwidth utilization. The scalable nature of these architectures may allow for flexible configuration of the number of banks, superbanks, lanes, and port groups to optimize the balance between routing complexity and system performance, making these solutions applicable across a wide range of computing environments including multicore processors, graphics processing units, network systems, and high-performance computing applications where multiple clients require efficient, low-latency access to shared memory resources.

A system in accordance with this disclosure can include at least one non-transitory computer readable media. The non-transitory computer readable media can store data required for the execution of any of the methods disclosed herein, the instruction data disclosed herein, and/or the operand data disclosed herein. The computer-readable media can also store instructions which, when executed by the system, cause the system to execute the methods disclosed herein. The concept of executing instructions is used herein to describe the operation of a device conducting any logic or data movement operation, even if the “instructions” are specified entirely in hardware (e.g., an AND gate executes an “and” instruction). The term is not meant to impute the ability to be programmable to a device.

While the specification has been described in detail with respect to specific embodiments of the invention, it will be appreciated that those skilled in the art, upon attaining an understanding of the foregoing, may readily conceive of alterations to, variations of, and equivalents to these embodiments. For example, while the example of multicore processors was referred to throughout the disclosure as an environment in which a multiport memory can operate, specific embodiments disclosed herein are more broadly applicable to memory systems that operate in any computing environment in which multiple clients need to access a shared memory these include graphics processing units (GPUs), network routers and switches, digital signal processing (DSP) systems, cache memories in high-performance computing (HPC) applications, embedded systems, field-programmable gate arrays (FPGAs), communication buffers, and database systems. These and other modifications and variations to the present invention may be practiced by those skilled in the art, without departing from the scope of the present invention, which is more particularly set forth in the appended claims.

What is claimed is:

1. A shared memory system comprising:
a set of port groups;
a set of selection circuits coupled to the set of port groups in a one-to-one correspondence;
a set of memory banks; and
a time division multiplexing control system, coupled to a set of control inputs of the set of selection circuits, to couple, in a cycle of one-to-one correspondences, the set of port groups through the set of selection circuits to the set of memory banks.

2. The shared memory system of claim 1, further comprising:
a set of cross bar circuits in a one-to-one correspondence with the set of memory banks;
wherein the set of port groups are coupled through the set of selection circuits and the set of cross bar circuits in the cycle of one-to-one correspondences.

3. The shared memory system of claim 2, wherein:
the cycle of one-to-one correspondences cycles with a series of memory access requests to the shared memory system; and
the series of memory access requests configure the set of cross bar circuits.

4. The shared memory system of claim 2, further comprising:
a set of arbitrators that each uniquely receive a series of memory access requests from a set of series of memory access requests;
wherein the set of arbitrators produce control information for the set of cross bar circuits.

5. The shared memory system of claim 1, wherein the set of port groups are a set of input port groups, and further comprising:
a set of output port groups; and
a second set of selection circuits coupled to the set of output port groups in a second one-to-one correspondence;
wherein the time division multiplexing control system is coupled to a second set of control inputs of the second set of selection circuits to couple, in a second cycle of one-to-one correspondences the set of memory banks to the set of output port groups through the second set of selection circuits.

6. The shared memory system of claim 1, wherein:
the set of selection circuits are a set of multiplexers; and
the time division multiplexing control system is an oscillator that cycles the connectivity state of the multiplexers.

7. The shared memory system of claim 1, wherein:
each port of the set of port groups services a client from a set of clients that share the shared memory system.

8. The shared memory system of claim 1, wherein:
a client of the shared memory system sequentially accesses contiguously addressed data in the shared memory system; and
the contiguously addressed data is distributed in the set of memory banks in accordance with the cycle of one-to-one correspondences.

9. The shared memory system of claim 1, wherein:
each memory bank in the set of memory banks includes subsets of the memory bank;
each subset of each memory bank comprises a group of memory addresses that have at least one memory address bit in common;
each port group in the set of port groups includes subsets of the port group; and
each subset of a port group corresponds to a subset of a memory bank in a second one-to-one correspondence.

10. The shared memory system of claim 9, wherein a port in a subset of a port group routes a memory access request based on one or more bits of a memory address of the memory access request.

11. The shared memory system of claim 9, wherein a port in a subset of a port group routes a memory access request to the corresponding subset of a memory bank based on one or more least significant bits of a memory address of the memory access request.

12. A shared memory system comprising:
a set of memory banks;
a set of cross bar circuits, each cross bar circuit of the set of cross bar circuits being uniquely coupled with a memory bank of the set of memory banks; and
a selection circuit selectively coupled to each cross bar circuit of the set of cross bar circuits;
wherein the selection circuit routes an access request to a cross bar circuit of the set of cross bar circuits based on one or more bits of a memory address of the access request.

13. A method for operating a shared memory system comprising:
coupling a set of port groups through a set of selection circuits to a set of memory banks in a cycle of one-to-one correspondences based on a time division multiplexing control system coupled to a set of control inputs of the set of selection circuits;
wherein the set of selection circuits are coupled to the set of port groups in a one-to-one correspondence.

14. The method of claim 13, wherein:
a set of cross bar circuits are in a one-to-one correspondence with the set of memory banks; and
the set of port groups are coupled through the set of selection circuits and the set of cross bar circuits in the cycle of one-to-one correspondences.

15. The method of claim 14, further comprising:
cycling the one-to-one correspondences with a series of memory access requests to the shared memory system; and
configuring, based on the series of memory access requests, the set of cross bar circuits.

16. The method of claim 14, further comprising:
uniquely receiving, at each arbitrator of a set of arbitrators, a series of memory access requests from a set of series of memory access requests; and
producing, by the set of arbitrators, control information for the set of cross bar circuits.

17. The method of claim 13, wherein the set of port groups are a set of input port groups and a second set of selection circuits are coupled to a set of output port groups in a second one-to-one correspondence, and further comprising:
coupling the set of output port groups through the second set of selection circuits to the set of memory banks in a second cycle of one-to-one correspondences based on the time division multiplexing control system coupled to a second set of control inputs of the second set of selection circuits.

18. The method of claim 13, wherein:
the set of selection circuits are a set of multiplexers; and
the time division multiplexing control system is an oscillator that cycles the connectivity state of the multiplexers.

19. The method of claim 13, wherein:
each port of the set of port groups services a client from a set of clients that share the shared memory system.

20. A method for operating a shared memory system comprising:
routing, via a selection circuit, an access request to a cross bar circuit of a set of cross bar circuits based on one or more bits of a memory address of the access request;
wherein the selection circuit is selectively coupled to each cross bar circuit of the set of cross bar circuits and each cross bar circuit is uniquely coupled with a memory bank of a set of memory banks.
